(19) United States
(12) Patent Application Publication
(10) Pub. No.: US 2025/0190333 A1
(43) Pub. Date: Jun. 12, 2025

(54) PREDICTING USER EXPERIENCE ON COMPUTING DEVICES FROM HARDWARE SPECIFICATIONS

(71) Applicant: GOOGLE LLC, Mountain View, CA (US)

(72) Inventors: Saswat Padhi, San Jose, CA (US); Sunil Kumar Bhasin, San Jose, CA (US); Naga Viswanadha Udaya Kiran Ammu, Santa Clara, CA (US); Alexander Bergman, Leichhardt (AU); Allan Douglas Knies, Burlingame, CA (US)

(21) Appl. No.: 18/974,576

(22) Filed: Dec. 9, 2024

Related U.S. Application Data
(60) Provisional application No. 63/607,935, filed on Dec. 8, 2023.

(51) Int. Cl. G06F 11/3668

(52) U.S. Cl. CPC G06F 11/3684

(57) ABSTRACT

A method including receiving first data including a feature corresponding to an application, receiving second data including a specification of a component included in a device, analyzing a performance of the device based on the first data and the second data using a model, and modifying the specification based on the performance of the device.

### CROSS-REFERENCE TO RELATED APPLICATION

This application claims the benefit and priority to U.S. Provisional Application No. 63/607,935, filed on Dec. 8, 2023, the disclosure of which is incorporated by reference herein in its entirety.

### BACKGROUND

Device makers (e.g., computer devices) rely on microbenchmark scores that stress test specific hardware components, such as CPU or RAM, but do not satisfactorily capture consumer workloads. These microbenchmarks are useful for stress testing a system, revealing the peak system performance. However, they do not satisfactorily model the average user experience. System designers often rely on domain-specific heuristics and extensive testing of prototypes to reach a desired user experience goal, and yet there is often a mismatch between the manufacturers' performance claims and the consumers' experience

### SUMMARY

Some implementations relate to predicting device performance using machine learning (ML). A model is trained to predict device performance for end-user workloads (e.g., web browsing, gaming, video playback, audio/video calls, and other applications) for specific device hardware. Then, when developing device hardware for a specific end-user workload performance metrics can be obtained and the device specifications can be modified as necessary.

In a general aspect, a device, a system, a non-transitory computer-readable medium (having stored thereon computer executable program code which can be executed on a computer system), and/or a method can perform a process with a method including receiving first data including a feature corresponding to an application, receiving second data including a specification of a component included in a device, analyzing a performance of the device based on the first data and the second data using a model, and modifying the specification based on the performance of the device.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1 illustrates a block diagram of a data flow for predicting a performance metric of a device according to at least one example implementation.

FIG. 2 illustrates a block diagram of a user interface (UI) according to an example implementation.

FIG. 3 is a block diagram of a method of training a model according to an example implementation.

FIG. 4 illustrates a block diagram of a method of developing device specifications according to an example implementation.

FIG. 5 illustrates a block diagram of a method of developing device specifications according to an example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

At least one technical problem can be that device manufacturers have difficulty estimating the overall user experience (UX) for a device without first manufacturing the device (or a prototype of the device). For example, it can be difficult for a computer device manufacturer to specify computer components (e.g., processor, RAM, and the like) to meet performance metrics for a workload (e.g., web browsing, gaming, video playback, audio/video calls, and other applications). The performance metrics can be associated with an application(s) (e.g., gaming, office, school) operating on a device running an operating system. The technical problem can further include needing to specify device components, build a device using the components, and test the device to determine if the computer meets some criteria. If the computer does not meet the criteria, the process is repeated over and over until a computer meets the criteria. This process can be expensive and inefficient.

At least one technical solution, as described herein, can include predicting real-life user experience on a device from the device's hardware specifications (sometimes referred to as a device design). For example, implementations can include using a model to estimate the performance of a computer using a user interface (UI) to input computer components and workloads. For example, a computer manufacturer may be developing a gaming laptop with a particular operating system (OS). The manufacturer can use the UI with the hardware specifications for the computer and predict device performance for a group of gaming applications (e.g., web-based and installed games). The manufacturer can then modify the hardware specifications to meet their performance criteria without manufacturing the computer (or without manufacturing a prototype of the computer).

At least one technical benefit of this solution is that a manufacturer can specify computer hardware for a workload (e.g., web browsing, gaming, video playback, audio/video calls, and other applications) without having to build and test the computer to determine if the hardware specifications meet the performance criteria.

By not having to build and test the computer to determine if the hardware specifications meet the performance criteria a manufacturer can shorten the time to market for new devices. Device manufacturers have been searching for a solution to the problem of having to build or prototype new devices to verify the performance of the new device. Therefore, there has been a long-felt need for the technology described herein. In other words, device manufacturers have been unable to verify the performance of a new device without building or prototyping the device for many years. The development of the subject matter described herein solves this problem and/or long-felt need.

In some implementations, a model can be trained to predict device performance for end-user workloads (e.g., web browsing, gaming, video playback, audio/video calls, and other applications) for specific device hardware. Then, when developing device hardware for established end-user workload, performance metrics can be obtained, and the device hardware specifications can be modified as necessary to meet the performance metrics.

In some implementations, the performance metric can be based on latency including an application startup time, a tab (e.g., web page tab) switch time, an image display (sometimes referred to as paint) time, and/or the like. In some implementations, the performance metric can be based on responsiveness including how long an event is in a queue, key press delay, mouse press delay, and the like. In some implementations, the performance metric can be based on smoothness including a fraction of dropped frames, window animation, tab switch animation, and the like. These are just a few example performance metrics. Other performance metrics are within the scope of this disclosure.

Most existing technologies evaluate CPU performance without considering other components of the device. Whereas example implementations can estimate or predict the performance of other components and combinations of components depending on the data used to train the model. Some implementations can be configured to use a Tree-based model. A tree-based model (e.g., a regression tree model, a gradient boosted tree model, and the like) can be configured to predict a value of a target variable based on several input variables. A regression tree model can be configured to divide data into subsets or branches, nodes, and leaves and select splits that decrease the dispersion of target variables.

Some implementations present results on predicting real-life user experience on laptops from their hardware specifications. Some implementations target web applications that run on laptops for a simple and fair aggregation of experience across applications and workloads (e.g., web browsing, video playback and audio/video calls, and the like). Some implementations emphasize a subset of high-level metrics exposed by a browser that are related to measuring user experience on web applications.

A computer manufacturer can be tasked with building a new computer using a predetermined operating system. This new computer can be targeted for a specific end-user use case (e.g., gaming, workplace, school, and the like). Therefore, the new computer can have performance specifications based on the end-user use case. Typically, the new computer would have to be built and tested by the computer manufacturer to determine if the new computer meets the performance specifications. Some implementations can predict or estimate the new computer performance without building the new computer.

Accordingly, implementations relate to predicting device performance using machine learning (ML). A model is trained to predict device performance for end-user workloads (e.g., web browsing, gaming, video playback, audio/video calls, and other applications) for specific device hardware. Then, when developing device hardware for a specific end-user workload performance metrics can be obtained and the device specifications can be modified as necessary.

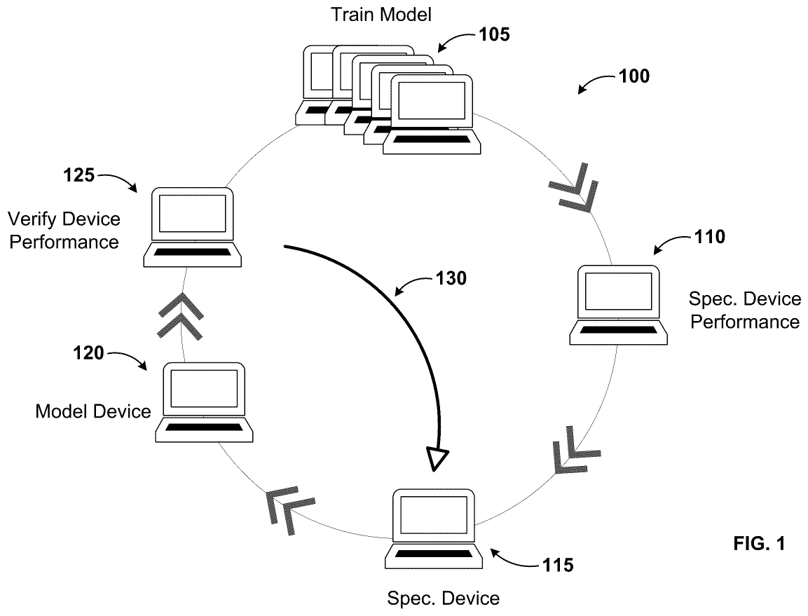

FIG. 1 illustrates a block diagram of a data flow for predicting a performance metric of a device (e.g., a computer) design according to at least one example implementation. As shown in FIG. 1, the data flow 100 includes a model training 105 process, a specification of device performance 110 process, a specify device 115 process, a model device 120 process, and a verify device performance 125 process.

As shown in FIG. 1, a model(s) can be trained 105 using data associated with a plurality of devices (e.g., computers). Data regarding specifications and performance of 100s, 1000s, 100,000s, and the like devices can be collected. This data can be used to train a model (e.g., a regression tree model, a gradient boosted regression tree model, and the like). The training of the model can enable predicting or estimating the performance of a new device based on the specifications and performance of existing devices. Accordingly, use of the model can enable predicting or estimating the performance of a new device without building or prototyping the new device.

Therefore, a new device performance requirement(s) can be specified 110 based on, for example, a workload using an operating system. As described above, a solution to the problem described above is that a manufacturer can specify computer hardware for a workload (e.g., web browsing, gaming, video playback, audio/video calls, and other applications) without having to build and test the computer to determine if the hardware specifications meet the performance criteria. Therefore, the new device performance requirement(s) can be specified 110 and components for the device can be specified 115 to satisfy the specified requirements 110. Accordingly, as described in more detail below, the new device does not need to be built or prototyped. This can be referred to as a device design.

After the components for the device are specified 115 to meet the device performance requirements, in some implementations the components for the device or the device design can be modeled. The device can be modeled using the trained model (e.g., a regression tree model, a gradient boosted regression tree model, and the like) described above.

In some implementations, the components representing the device design can be input (e.g., using a user interface (UI)) to the model (e.g., a trained model) configured to predict (or estimate) 120 the performance of the device design. Then, the performance of the design of the device can be verified 125 (e.g., does the device design meet a criterion (or criteria) associated with a performance metric). In other words, the performance of the new device can be predicted or estimated without the need to build or prototype the new device or device design.

If the device design does not meet the criteria, the components for the design of the device can be modified and modelled again. This is illustrated as loop 130 as shown in FIG. 1. In some implementations, loop 130 can be performed a plurality of times until the device design meets the criteria. In other words, the device design can be specified 115, modelled 120, and verified 125 a plurality of times (loop 130) until the device design satisfies the criteria associated with the specification of device performance 110.

Sometimes having enough data to train a model and verifying the model has been sufficiently trained can be a challenge. However, a dataset of 100K or more user experience (UX) data points has been developed over several years. This dataset can include data associated with device components, device operating systems, and associated device performance metrics.

Accordingly, the dataset can be used to train 105 a plurality of models. As mentioned above, in some implementations a model can be trained 105 to generate a corresponding performance metric. In some implementations a subset of the data can be separated from the dataset and used to verify the training 105 of the model. For example, the dataset can include a set of unique data for a performance metric. Training 105 a model can include using, for example, a first subset of the set of unique data for the performance metric for the training and a second subset of the set of unique data for the performance metric for the verification of the training. For example, the dataset can include 500 unique data for a performance metric. Training 105 a model can include using, for example, a subset of 450 unique data for the training and 50 unique data for the verification of the training. In some implementations, one model can be trained to predict or estimate one performance metric. In some implementations, one model can be trained to predict or estimate two or more performance metrics.

In some implementations, the model can be a tree-based regression model. In some implementations, the model can be a gradient boosted regression tree model. A tree-based model can be configured to generate predictions from one or more decision trees. A regression model can be a machine learning technique, used to predict the value of a dependent variable for new, unseen data. For example, a regression model can model a relationship between one or more input features and a variable. A regression model can be used to estimate or predict a numerical value(s). A tree-based regression model can use a fast divide and conquer greedy algorithm that recursively partitions data (e.g., the given training data) into smaller subsets. A gradient boosted regression tree model can use a plurality of decision trees. A gradient boosted regression tree model can use a plurality of decision trees sequentially to compensate for errors associated with previous trees. In some implementations, gradient boosted regression trees configured to predict the performance metric values from device specifications are trained 105 using training data associated with a plurality of workloads, a plurality of operating systems, and/or a plurality of device hardware components.

A new device (e.g., computer device) performance requirement(s) can be specified 110 based on, for example, a workload using an operating system. The performance of the new device can be based on a feature(s) corresponding to an application to be executed on the device (e.g., a workload) and a specification of a component(s) included in the device. Accordingly, next the components for the device can be specified 115. The components can be specified to meet the device performance requirements (e.g., some criteria). Computer hardware development can evolve rapidly. Therefore, the number of possible component specifications used to assemble a system can grow exponentially as the available options for the various components (e.g., CPU, GPU, RAM, display, and the like) multiply.

Accordingly, in some implementations the components for the device can be input (e.g., using a user interface (UI) to a model (e.g., a trained model) configured to predict (or estimate) 120 the performance of the device design. For example, tests can be defined for an application (e.g., web-based application) executed on an OS that mimic end-user workloads on the OS. A subset of performance metrics that correlate with perceivable UX degradation can be identified (e.g., by the operator of the test). These UX metrics can be evaluated across tests, and curate hardware specifications (e.g., UX performance metrics dataset with 100K data points). Then, a set of trained gradient boosted regression trees models that predict 120 these UX performance metrics can be used.

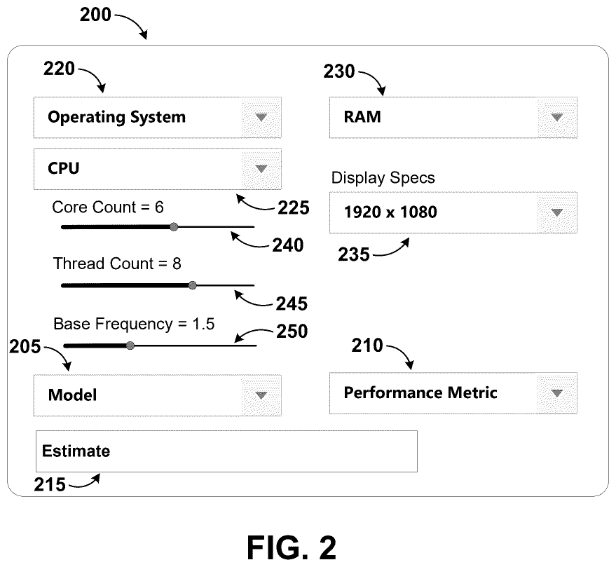

FIG. 2 illustrates a block diagram of a user interface (UI) according to an example implementation. As shown in FIG. 2, a UI 200 can have a plurality of data input elements and/or data display elements. For example, the UI 200 can include a model 205 dropdown box, a performance metric 210 dropdown box, an operating system 220 dropdown box, a CPU 225 dropdown box, a RAM 230 dropdown box, and a display specification 235 dropdown box as data input elements. For example, the UI 200 can include an estimate 215 display box as a data display element. Other (not shown for clarity purposes) data input elements and/or data display elements can be included in UI 200.

In some implementations, the UI 200 can include a model 205 dropdown box. The model 205 dropdown box can be used to select a model 205 (e.g., a trained model, a trained gradient boosted regression tree model, and the like) for modeling a device design (e.g., a computer). In some implementations, the model 205 can be configured (e.g., trained) to estimate or predict one performance metric. However, in some implementations, the model 205 can be configured (e.g., trained) to estimate or predict two or more performance metrics. Therefore, the UI 200 can include a performance metric 210 dropdown box.

The performance metric 210 dropdown box can be used to select a performance metric 210 to estimate or predict using model 205. The UI 200 can also include an estimate 215 display box configured to display a numeric value representing the result of the estimation or prediction. In some implementations, the performance metric 219 can be based on latency including an application startup time, a tab (e.g., web page tab) switch time, an image display (sometimes referred to as paint) time, and/or the like. In some implementations, the performance metric can be based on responsiveness including how long an event is in a queue, key press delay, mouse press delay, and the like. In some implementations, the performance metric can be based on smoothness including a fraction of dropped frames, window animation, tab switch animation, and the like. These are just a few example performance metrics. Other performance metrics are within the scope of this disclosure.

In some implementations, the model 205 dropdown box can include 100s or 1000s of models 205 (e.g., trained models) used to estimate or predict a performance metric of a device design. The models 205 can be trained using data collected from devices executing one of many operating systems. The device design that is having its performance estimated can be using one of the many operating systems. Therefore, UI 200 can include an operating system 220 dropdown box. For example, data associated with devices used for training can include devices using any of the common operating systems. Further, data associated with devices used for training can include devices using a device specific operating system. For example, the operating system could be a custom operating system used for a wearable device (e.g., smart glasses).

The operating system 220 dropdown box can be used to select an operating system 220 which can cause the model 205 dropdown box to only include models 205 associated with the selected operating system 220. In some implementations, the models 205 can be trained using data from devices that use the same operating system 220. In such a case, the operating system 220 dropdown box may not be included with the UI 200 or the operating system 220 dropdown box can be disabled such that no operating system 220 can be selected.

In some implementations, first data and second data can be input to the UI 200. First data can include a feature corresponding to an application. Second data can include a specification of a component included in a device. In some implementations, the model can be trained with data that includes the feature corresponding to an application. For example, an application can be a workload (as described above). Therefore, the features can correspond to the workload. Therefore, the features could be related to a game, an office application, a school application, and the like and/or how the game, office application, school application, and the like are used. In other words, the first data can be incorporated into the training of the model. Therefore, selecting the model 205 can cause the receiving of the first data including a feature corresponding to an application.

In some implementations, the specification(s) of a component included in a device can be selected using the UI 200. For example, the component included in a device can correspond to the device design. Accordingly, selecting components using the UI 200 can include selecting a CPU, RAM, display characteristics, and the like. Therefore, receiving second data including a specification of a component included in a device can be responsive to making selections and/or entering data into the UI 200 as described in more detail below.

A model 205 can use input data associated with the device design that is having its performance estimated. UI 200 includes data input elements to input a specification of a component included in the device design. The UI 200 illustrates a few examples of data input elements. However, other data input elements are within the scope of this disclosure. As shown in FIG. 2, UI 200 can include a CPU 225 dropdown box, a RAM 230 dropdown box, and a display specification 235 dropdown box. Further, the CPU 225 can have additional specifications including (but not limited to) core count 240, thread count 245, and base frequency 250.

As mentioned above, a new device performance can be specified and components for the new device can be specified based on the performance. A user (e.g., device designer, engineer, and the like) can enter the component specifications into UI 200. For example, the user can enter the CPU 225, the core count 240, the thread count 245, and the base frequency 250 for the CPU 225. The user can further enter the RAM 230 and the display specifications 235. Then a performance metric 210 can be estimated or predicted and a numeric value representing the performance metric 210 can be displayed in the estimate 215 display box. If the numeric value representing the performance metric 210 does not meet some criteria based on the specified new device performance, one or more of the component specifications can be changed or modified in UI 200. For example, the base frequency 250 of the CPU 225 can be changed from 1.5 (as shown in FIG. 2) to a different value (e.g., 2.0). Then, the performance metric 210 can be estimated or predicted again and a numeric value representing the performance metric 210 can be displayed in the estimate 215 display box again. This process can be repeated where any of the component specifications can be changed or modified until the performance metric 210 meets the criteria.

As mentioned above, the model (e.g., a gradient boosted regression tree model) can be trained to generate a corresponding performance metric. In some implementations, one model can be trained to predict or estimate one performance metric. In some implementations a subset of the data can be separated from the dataset and used to verify the training of a model. For example, the dataset can include a set of unique data for a performance metric. Training 105 a model can include using, for example, a first subset of the set of unique data for the performance metric for the training and a second subset of the set of unique data for the performance metric for the verification of the training. For example, the dataset can include 500 unique data for a metric. Training a model can include using, for example, a subset of 450 unique data for the training and 50 unique data for the verification of the training.

Causing the model to operate can generate the performance metric. Therefore, analyzing a performance of the device based on the first data and the second data using a model can be implemented in UI 200 via execution of the model after inputting the data described above. The performance can be indicative of whether the device design criteria associated with the specification of device performance. If the device design fails to satisfy the criteria the specification can be modified based on the performance of the device. In other words, if the device design does not meet the criteria, the components for the design of the device can be modified and modelled again. This is illustrated as loop 130 as shown in FIG. 1. In some implementations, the device design can be analyzed a plurality of times until the device design satisfies, meets, or passes the criteria. In other words, the device design can be specified, modelled, and verified a plurality of times until the device design satisfies the criteria associated with the specification of device performance.

Sometimes having enough data to train a model and verifying the model has been sufficiently trained can be a challenge. However, a dataset of 100K or more user experience (UX) data points has been developed over several years. This dataset can include data associated with device components, device operating systems, and associated device performance metrics.

Accordingly, the dataset can be used to train a plurality of models. As mentioned above, in some implementations a model can be trained to generate a corresponding performance metric. In some implementations a subset of the data can be separated from the dataset and used to verify the training of the model. For example, the dataset can include a set of unique data for a performance metric. Training a model can include using, for example, a first subset of the set of unique data for the performance metric for the training and a second subset of the set of unique data for the performance metric for the verification of the training. For example, the dataset can include 500 unique data for a performance metric. Training a model can include using, for example, a subset of 450 unique data for the training and 50 unique data for the verification of the training. In some implementations, one model can be trained to predict or estimate one performance metric. In some implementations, one model can be trained to predict or estimate two or more performance metrics.

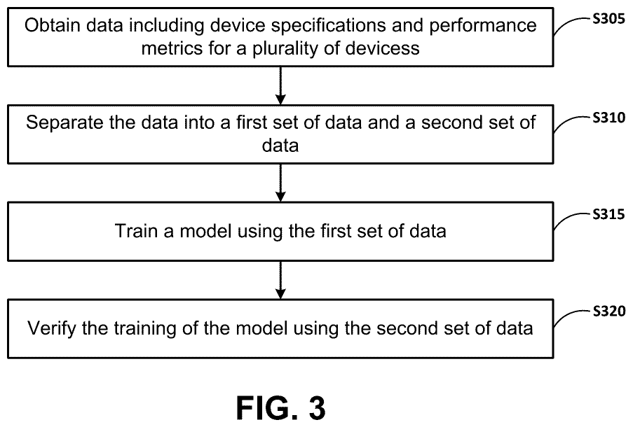

FIG. 3 is a block diagram of a method of training a model according to an example implementation. As shown in FIG. 3, in step S305 obtain data including device specifications and performance metrics for a plurality of devices (e.g., computers). For example, a dataset including a collection of devices (e.g., computers), target workloads and UX performance metrics for specific tests can be read from a data store (e.g., a memory). In step S310 separate the data into a first set of data and a second set of data. For example, a portion of the dataset can be separated from the dataset forming a first set and a second set of data.

In step S315 train a model using the first set of data. For example, training the model can include using a loss function that is minimized on the first set of data. In some implementations the loss function can be the Mean Squared Error (MSE) using Friedman's least-squares improvement criterion. In step S320 verify the training of the model using the second set of data. For example, the trained model can use the device specifications of the second set of data as input and the performance metrics of the second set of data can be used to verify that the model is predicting the correct results for the performance metric (e.g., predicting the same (or within an acceptable margin) numeric value for the performance metric). A prediction error rate can be used to validate the training. The prediction error rate may satisfy a criteria to identify the model as successfully trained. For prediction error rate, the Mean Arctangent Absolute Percentage Error (MAAPE) can be calculated which provides a stable relative error even when the true values are zero.

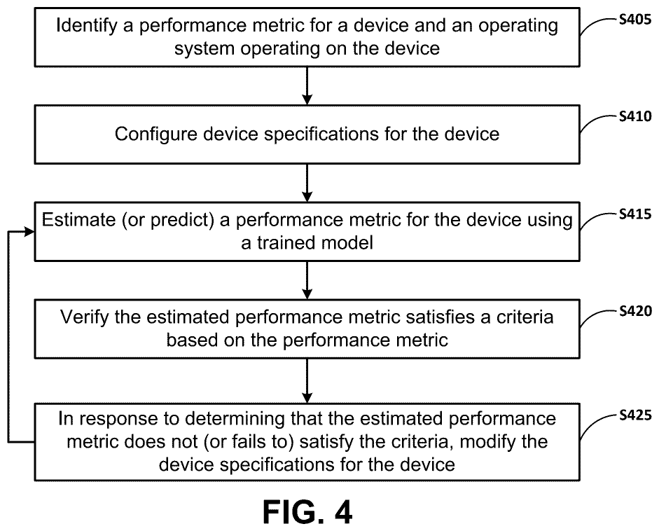

FIG. 4 is a block diagram of a method of developing device specifications according to an example implementation. As shown in FIG. 4, in step S405 identify a performance metric for a device. The performance metric can be based on the operating system operating on the device and the workload. The target workloads can be based on end-user telemetry data. The workloads can focus on web browsing, document editing, audio/video calling, and video playback. Tests that mimic these use cases can be used. In some implementations, the performance metric can be based on latency including an application startup time, a tab (e.g., web page tab) switch time, an image display (sometimes referred to as paint) time, and/or the like. In some implementations, the performance metric can be based on responsiveness including how long an event is in a queue, key press delay, mouse press delay, and the like. In some implementations, the performance metric can be based on smoothness including a fraction of dropped frames, window animation, tab switch animation, and the like.

In step S410 configure device specifications for the device. For example, a device designer can specify components or hardware (e.g., CPU, RAM, and the like) that the device designer expects to meet the performance metric(s). In step S415 estimate (or predict) a performance metric for the device design using a trained model. A performance metric m can be a function ƒₘ that is trained that given a vector x of hardware specifications predicts an estimated value ŷₘ for the metric m (with some true value yₘ) based on the model parameters \hat{β} learned during training.

$${\hat{y}}_{m} = {f}_{m} ( x , \hat{β} )$$

$$where : x = 〈 {x}_{cpu \_ freq} , ... , {x}_{{ram}_{capacity}} , ... , {x}_{display \_ res} 〉$$

Some performance metrics from tests that terminate before completion can be discarded. In addition, extreme values, such as 100% dropped frames and 0% smoothness can be discarded. To reduce the impact of outliers, the median of the multiple per-test iterations may be used.

Tree-based models have been shown to be more effective than neural models, especially at regression on tabular data, (e.g., data with a fixed set of features). Tabular data often poses challenges for neural networks: lack of locality, data sparsity, mixed feature types etc. Further, given their determinism and interpretability, some implementations use Gradient Boosted Regression Trees (GBRTs). Some implementations clip the outputs of our GBRTs from below at zero, since all the metrics assume non-negative values.

In step S420 verify the estimated performance metric satisfies a criteria based on the performance metric. In step S425 in response to determining that the estimated performance metric does not (or fails to) satisfy the criteria, modify the device specifications for the device design. Modifying device design specifications can be based on correlating a device specification to performance improvement. For example, changing a CPU thread count may have a larger impact on performance than CPU base frequency for a specific performance metric (e.g., latency). Processing then returns to step S415.

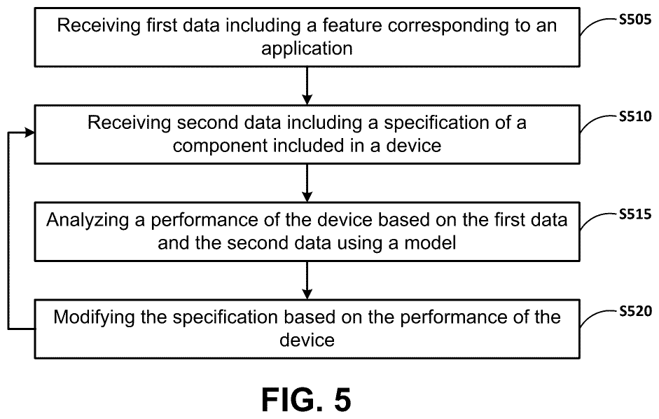

Example 1. FIG. 5 is a block diagram of a method of developing device specifications according to an example implementation. As shown in FIG. 5, in step S505 receiving first data including a feature corresponding to an application. In step S510 receiving second data including a specification of a component included in a device design. In step S515 analyzing a performance of the device design based on the first data and the second data using a model. In step S520 modifying the specification based on the performance of the device design.

In some implementations, first data and second data can be input to the UI 200. First data can include a feature corresponding to an application. Second data can include a specification of a component included in a device. In some implementations, the model can be trained with data that includes the feature corresponding to an application. For example, an application can be a workload (as described above). Therefore, the features can correspond to the workload. Therefore, the features could be related to a game, an office application, a school application, and the like and/or how the game, office application, school application, and the like are used. In other words, the first data can be incorporated into the training of the model. Therefore, selecting the model 205 can cause the receiving of the first data including a feature corresponding to an application.

In some implementations, the specification(s) of a component included in a device can be selected using the UI 200. For example, the component included in a device can correspond to the device design. Accordingly, selecting components using the UI 200 can include selecting a CPU, RAM, display characteristics, and the like. Therefore, receiving second data including a specification of a component included in a device can be responsive to making selections and/or entering data into the UI 200 as described in more detail below.

Example 2. The method of Example 1, where the performance can be a first performance and the model can be a first model, the method can further include selecting a second model and analyzing a second performance based on the first data and the second data using the second model, wherein the modifying of the specification is based on the first performance and the second performance.

Example 3. The method of Example 2, wherein the modifying of the specification can include selecting a first specification or a second specification based on a value associated with the first performance and the second performance.

Example 4. The method of Example 1, wherein the first data can be tabular data, the second data can be tabular data, and the model can be a tree-based regression model configured to perform a regression on tabular data.

Example 5. The method of Example 4, wherein the tree-based regression model can be a gradient boosted regression tree model.

Example 6. The method of Example 1, wherein training the model can include selecting training data based on an operating system and a metric associated with the performance, separating the training data into a first subset of data and a second subset of data, training the model using the first subset of data as input, and evaluating the training of the model based on the second subset of data.

Example 7. The method of Example 6, wherein the evaluating of the training of the model can include determining a prediction error rate satisfies a criteria.

Example 8. The method of Example 1, wherein the performance of the device design can be based on a function that is trained that given a vector of hardware specifications predicts an estimated value for the performance based on model parameters learned during training.

Example 9. A method can include any combination of one or more of Example 1 to Example 8.

Example 10. A non-transitory computer-readable storage medium comprising instructions stored thereon that, when executed by at least one processor, are configured to cause a computing system to perform the method of any of Examples 1-9.

Example 11. An apparatus comprising means for performing the method of any of Examples 1-9.

Example 12. An apparatus comprising at least one processor and at least one memory including computer program code, the at least one memory and the computer program code configured to, with the at least one processor, cause the apparatus at least to perform the method of any of Examples 1-9.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed is:

1. A method comprising:
receiving first data including a feature corresponding to an application;
receiving second data including a specification of a component included in a device;
analyzing a performance of the device based on the first data and the second data using a model; and
modifying the specification based on the performance of the device.

2. The method of claim 1, wherein the performance is a first performance and the model is a first model, the method further comprising:
selecting a second model; and
analyzing a second performance based on the first data and a second data using the second model, wherein the modifying of the specification is based on the first performance and the second performance.

3. The method of claim 2, wherein the modifying of the specification includes selecting a first specification or a second specification based on a value associated with the first performance and the second performance.

4. The method of claim 1, wherein,
the first data is tabular data,
the second data is tabular data, and
the model is a tree-based regression model configured to perform a regression on tabular data.

5. The method of claim 4, wherein the tree-based regression model is a gradient boosted regression tree model.

6. The method of claim 1, wherein training the model includes:
selecting training data based on an operating system and a metric associated with the performance;
separating the training data into a first subset of data and a second subset of data;
training the model using the first subset of data as input; and
evaluating the training of the model based on the second subset of data.

7. The method of claim 6, wherein the evaluating of the training of the model includes determining a prediction error rate satisfies a criteria.

8. The method of claim 1, wherein the performance of the device is based on a function that is trained that given a vector of hardware specifications predicts an estimated value for the performance based on model parameters learned during training.

9. A non-transitory computer-readable storage medium comprising instructions stored thereon that, when executed by at least one processor, are configured to cause a computing system to:
receive first data including a feature corresponding to an application;
receive second data including a specification of a component included in a device;
analyze a performance of the device based on the first data and the second data using a model; and
modify the specification based on the performance of the device.

10. The non-transitory computer-readable storage medium of claim 9, wherein the performance is a first performance and the model is a first model, the instructions are further configured to cause the computing system to:
selecting a second model; and
analyzing a second performance based on the first data and the second data using the second model, wherein the modifying of the specification is based on the first performance and the second performance.

11. The non-transitory computer-readable storage medium of claim 10, wherein the modifying of the specification includes selecting a first specification or a second specification based on a value associated with the first performance and the second performance.

12. The non-transitory computer-readable storage medium of claim 9, wherein,
the first data is tabular data,
the second data is tabular data, and
the model is a tree-based regression model configured to perform a regression on tabular data.

13. The non-transitory computer-readable storage medium of claim 12, wherein the tree-based regression model is a gradient boosted regression tree model.

14. The non-transitory computer-readable storage medium of claim 9, wherein training the model includes:
selecting training data based on an operating system and a metric associated with the performance;
separating the training data into a first subset of data and a second subset of data;
training the model using the first subset of data as input; and
evaluating the training of the model based on the second subset of data.

15. The non-transitory computer-readable storage medium of claim 14, wherein the evaluating of the training of the model includes determining a prediction error rate satisfies a criteria.

16. The non-transitory computer-readable storage medium of claim 9, wherein the performance of the device is based on a function that is trained that given a vector of hardware specifications predicts an estimated value for the performance based on model parameters learned during training.

17. A user interface comprising:
a first data input element configured to receive first data including a feature corresponding to an application;
a second data input element configured to receive second data including a specification of a component included in a device;
a data display element configured to display a result of an analysis of a performance of the device based on the first data and the second data using a model; and
the second data input element further configured to modify the specification based on the performance of the device.

18. The user interface of claim 17, wherein the modifying of the specification includes selecting a revised specification based on a value associated with the performance.

19. The user interface of claim 17, wherein,
the first data is tabular data,
the second data is tabular data, and
the model is a tree-based regression model configured to perform a regression on tabular data.

20. The user interface of claim 19, wherein the tree-based regression model is a gradient boosted regression tree model.
